(19) United States
(12) Patent Application Publication
(10) Pub. No.: US 2012/0028069 A1
(43) Pub. Date: Feb. 2, 2012

(54) GRAIN-ORIENTED ELECTRICAL STEEL SHEET AND PRODUCING METHOD THEREFOR

(75) Inventors: Tatsuhiko Sakai, Tokyo (JP); Makoto Atake, Tokyo (JP); Shinya Hayashi, Tokyo (JP)

(73) Assignee: NIPPON STEEL CORPORATION, Tokyo (JP)

(21) Appl. No.: 13/138,533

(22) PCT Filed: Mar. 4, 2010
(86) PCT No.: PCT/JP2010/001516

§ 371 Date: Oct. 18, 2011

(30) Foreign Application Priority Data
Mar. 11, 2009 (JP) 2009-058500
Nov. 18, 2009 (JP) 2009-263216

(51) Int. Cl. B32B 3/30; B21D 35/00; B32B 15/18

(52) U.S. Cl. 428/593; 72/68; 72/56

(57) ABSTRACT

A producing method of a grain-oriented electrical steel sheet includes forming a preferentially-deformable portion at an end region of a steel sheet so as to be parallel with the rolling direction of the steel sheet; coiling the steel sheet; and performing a final annealing to the steel sheet after disposing the steel sheet in a manner such that the end region becomes the lower side of the steel sheet.

### BACKGROUND OF THE INVENTION

1. Field of the Invention

The present invention relates to a method of manufacturing a grain-oriented electrical steel sheet, which prevents lateral strain of a coil end portion brought into contact with a coil receiver in final annealing.

Priority is claimed on Japanese Patent Application No. 2009-058500, filed Mar. 11, 2009, and Japanese Patent Application No. 2009-263216, filed Nov. 18, 2009, the content of which is incorporated herein by reference.

2. Description of Related Art

In a method of manufacturing a grain-oriented electrical steel sheet, a cold-rolled steel sheet is wound in a coil after decarburization annealing, and is subject to a final annealing for the purpose of a secondary recrystallization at high temperatures of 1000° C. or higher. At the time of the final annealing, as shown in FIG. 1, a coil 5 is disposed on a coil receiver 8 in an annealing furnace cover 9 in a manner such that the coil axis 5a of the coil 5 becomes vertical.

When the coil 5 placed as described above is annealed at high temperatures, as shown in FIG. 2A, in a lower end portion 5z of the coil 5 brought into contact with the coil receiver 8, a buckling distortion called lateral strain is caused by the weight of the coil 5, a difference between the thermal expansions of the coil 5 and the coil receiver 8, or the like. As shown in FIG. 2B, the lateral strain is observed as a height h of a wave when the steel sheet unwound from the coil is disposed on a flat surface plate. In general, a lateral strain portion 5e is a deformed region of the end portion of the steel sheet, which satisfies a condition where the height h of wave exceeds 2 mm or a condition where a steepness s expressed by the following Equation (1) exceeds 1.5% (exceeds 0.015). The lateral strain portion 5e cannot be used as a product, since it is trimmed by round cutter or the like when the coil is unwound after the final annealing. Therefore, as the lateral strain portion 5e increases, the trimming width increases, whereby there is a problem in that the yield decreases.

S=h/l (1)

Here, l indicates the width of the lateral strain portion.

A generation mechanism of the lateral strain at the time of the final annealing is explained by a grain boundary sliding at high temperatures. Specifically, at a high temperature of 900° C. or more, the lateral strain caused by the grain boundary sliding becomes remarkable, such that in the grain boundary portion, lateral strain is apt to occur. A growing period of time of a secondary recrystallization in the lower end portion of the coil, which is brought into contact with the coil receiver, is slower than that in a center portion of the coil. Therefore, in the lower end portion of the coil, the grain size becomes small and thereby a refined grain portion is apt to be formed.

It is assumed that since many crystal grain boundaries are present in the refined grain portion, the grain boundary sliding occurs easily and thereby the lateral strain occurs. Accordingly, in the conventional technique, various methods have been suggested for suppressing a mechanical deformation by controlling crystal grain growth in the lower end portion of the coil.

In Patent Citation 1, there is disclosed a method where before the final annealing, a grain refiner is applied onto a band-shaped portion having a predetermined width from a lower end face of the coil that is brought into contact with the coil receiver and grains in the band-shaped portion are refined during the final annealing. In addition, in Patent Citation 2, a method is disclosed where before the final annealing, a strain (deformation) is applied to the band-shaped portion having a predetermined width from the lower end face of the coil that is brought into contact with the coil receiver by a roller or the like on which protrusions are formed, and the grains in the band-shaped portion are refined during the final annealing.

As described above, in the methods disclosed in Patent Citation 1 and Patent Citation 2, in order to suppress the lateral strain, the crystal grains in the lower end portion of the coil are intentionally refined and thereby the mechanical strength in the lower end portion of the coil is changed.

However, in the method where the grain refiner is applied, which is disclosed in Patent Citation 1, since the grain refiner is in the form of liquid, it is difficult to accurately control the application region. In addition, the grain refiner may be diffused from the end portion of the steel sheet toward the center portion of the steel sheet. Therefore, it is difficult to constantly control the width of a grain refining region, such that the width of the lateral strain portion may vary greatly in a longitudinal direction of the coil.

The width of the lateral strain portion, which is the most deformed, is set as a trimming width, such that even when the width of the lateral strain portion is large only in one place, the trimming width increases and thereby the yield is diminished.

In addition, in the method where the strain is applied, which is disclosed in Patent Citation 2, the crystal grains in the lower end portion of the coil are refined using the strain caused through a mechanical working by the roller or the like as a starting point. In this method, the grain refining region may be controlled relatively well. However, there is a problem in that since the roller is abraded due to continuously working over an extended period of time, the amount of strain (reduction ratio) applied diminishes with the passage of time and thereby the grain refining effect decreases. Particularly, the grain-oriented electrical steel sheet is a hard material containing a large amount of Si, such that the abrasion in the roller is severe, and thereby it is necessary to frequently replace the roller.

On the other hand, in Patent Citations 3 to 6, a method is disclosed where in order to suppress the lateral strain, the secondary recrystallization in the band-shaped portion having a predetermined width from the lower end face of the coil is developed, grain size is made to quickly increase during the final annealing, and thereby high temperature strength is improved.

As means for making the grain size large, Patent Citations 3 and 4 disclose a method where the band-shaped portion of the end portion of the steel sheet is heated by plasma heating or induction heating before the final annealing. In addition, in Patent Citations 3, 5, and 6, a method is disclosed where the strain is introduced by a mechanical working using a shot blast, a roller, a tooth roller, or the like.

The plasma heating and induction heating are heating methods in which a heating range is relatively wide, such that they are suitable to heat a band-shaped range. However, there is a problem in that in the plasma heating and induction heating, it is difficult to control a heating position and a heating temperature. In addition, there is a problem in that a region wider than a predetermined range is heated due to heat conduction. Therefore, it is difficult to constantly control the width of the region where the grain size increases by the secondary recrystallization, such that there is a problem in that non-uniformity may easily occur in the lateral strain suppressing effect.

In the method performed by a mechanical working using the roller or the like, as described above, there is a problem in that the strain application effect (amount of strain) is diminished with the passage of time due to the abrasion of the roller. Specifically, the rate of the secondary recrystallization varies significantly depending on the amount of strain, such that there is problem in that it is difficult to obtain a predetermined grain size to stably obtain the lateral strain suppressing effect even when the amount of strain due to the abrasion of the roller is small.
[Patent Citation 1] Japanese Unexamined Patent Application, First Publication No. S63-100131
[Patent Citation 2] Japanese Unexamined Patent Application, First Publication No. S64-042530
[Patent Citation 3] Japanese Unexamined Patent Application, First Publication No. H02-097622
[Patent Citation 4] Japanese Unexamined Patent Application, First Publication No. H03-177518
[Patent Citation 5] Japanese Unexamined Patent Application, First Publication No. 2000-038616
[Patent Citation 6] Japanese Unexamined Patent Application, First Publication No. 2001-323322

As described above, in the conventional technique, there is problem that since it is difficult to precisely perform the control (range and size) of the crystal grain size, it is difficult to obtain a sufficient lateral strain suppressing effect.

An object of the present invention is to solve the above-described problem in the conventional technique, and to suppress the lateral strain in the lower end portion of the coil that is brought into contact with the coil receiver inside the final annealing furnace, which is caused by a high temperature sliding in the final annealing.

That is, in the present invention, it is possible to provide a producing method of a grain-oriented electrical steel sheet where the suppression of a lateral strain may be stably and efficiently performed and the width of the lateral strain portion may be limited to be within a predetermined range.

### SUMMARY OF THE INVENTION

The inventors have intensively studied methods for solving the above-described problems. As a result, they have found that when a preferentially-deformable portion is formed to have a constant distance from an end face of the steel sheet, on a single face or both faces of an end region (first end portion) in one side of a steel sheet before the final annealing, the width of a lateral strain portion may be limited to be within a predetermined range. In addition, the preferentially-deformable portion is not formed at the end region (second end portion) at the other side of the steel sheet.

The present invention has been made on the basis of the above-described finding, and the summary of the present invention is as follows.

(1) A producing method of a grain-oriented electrical steel sheet includes forming a preferentially-deformable portion at an end region of a steel sheet so as to be parallel with the rolling direction of the steel sheet; coiling the steel sheet; and performing a final annealing to the steel sheet after disposing the steel sheet in a manner such that the end region becomes the lower side of the steel sheet.

(2) In the producing method of a grain-oriented electrical steel sheet according to (1), the preferentially-deformable portion may be continuously formed.

(3) In the producing method of a grain-oriented electrical steel sheet according to (1), the preferentially-deformable portion may be discontinuously formed.

(4) In the producing method of a grain-oriented electrical steel sheet according to (1), the preferentially-deformable portion may be formed over the entire length of the steel sheet.

(5) In the producing method of a grain-oriented electrical steel sheet according to (1), the preferentially-deformable portion may be formed at a part of the steel sheet in the rolling direction.

(6) In the producing method of a grain-oriented electrical steel sheet according to (1), the preferentially-deformable portion may be formed at a distance of 5 to 100 mm from the end face of the end region.

(7) In the producing method of a grain-oriented electrical steel sheet according to (1), when the final annealing is performed, the steel sheet may be disposed in a manner such that the direction of the coil axis of the steel sheet after being wound into the coil shape becomes perpendicular to the coil receiver.

(8) In the producing method of a grain-oriented electrical steel sheet according to (1), the preferentially-deformable portion may be formed before an annealing separator is applied on the steel sheet.

(9) In the producing method of a grain-oriented electrical steel sheet according to (1), the preferentially-deformable portion may be formed by irradiation of a laser beam.

(10) In the producing method of a grain-oriented electrical steel sheet according to (1), a groove may be formed in the preferentially-deformable portion.

(11) In the producing method of a grain-oriented electrical steel sheet according to (10), the groove may be formed on a single face of the steel sheet.

(12) In the producing method of a grain-oriented electrical steel sheet according to (10), the groove may be formed on both faces of the steel sheet.

(13) In the producing method of a grain-oriented electrical steel sheet according to (10), the width of the groove may be from 0.03 to 10 mm.

(14) In the producing method of a grain-oriented electrical steel sheet according to (10), a depth d of the groove and a thickness t of the steel sheet may satisfy the equation 0.05≦d/t≦0.7.

(15) In the producing method of a grain-oriented electrical steel sheet according to (1), the preferentially-deformable portion may be a grain boundary sliding portion.

(16) In the producing method of a grain-oriented electrical steel sheet according to (15), the grain boundary sliding portion after the final annealing may be one linear crystal grain boundary.

(17) In the producing method of a grain-oriented electrical steel sheet according to (15), the grain boundary sliding portion after the final annealing may be a sliding band including crystal grains.

(18) In the producing method of a grain-oriented electrical steel sheet according to (17), the width of the sliding band may be from 0.02 to 20 mm.

(19) In a grain-oriented electrical steel sheet, a thermally-deformed portion is formed at an end region of a steel sheet so as to be parallel with the rolling direction of the steel sheet.

(20) In the grain-oriented electrical steel sheet according to (19), the thermally-deformed portion may be continuously formed.

(21) In the grain-oriented electrical steel sheet according to (19), the thermally-deformed portion may be discontinuously formed.

(22) In the grain-oriented electrical steel sheet according to (19), the thermally-deformed portion may be formed over the entire length of the steel sheet.

(23) In the grain-oriented electrical steel sheet according to (19), the thermally-deformed portion may be formed at a part of the steel sheet in the rolling direction.

(24) In the grain-oriented electrical steel sheet according to (19), the thermally-deformed portion may be formed at a distance of 5 to 100 mm from the end face of the end region.

(25) In the grain-oriented electrical steel sheet according to (19), the thermally-deformed portion may be a groove.

(26) In the grain-oriented electrical steel sheet according to (25), the groove may be formed on a single face of the steel sheet.

(27) In the grain-oriented electrical steel sheet according to (25), the groove may be formed on both faces of the steel sheet.

(28) In the grain-oriented electrical steel sheet according to (25), the width of the groove may be from 0.03 to 10 mm.

(29) In the grain-oriented electrical steel sheet according to (25), a depth d of the groove and a thickness t of the steel sheet may satisfy the equation 0.05≦d/t≦0.7.

(30) In the grain-oriented electrical steel sheet according to (19), the thermally-deformed portion may be one linear crystal grain boundary.

(31) In the grain-oriented electrical steel sheet according to (19), the thermally-deformed portion may be a sliding band including crystal grains.

(32) In the grain-oriented electrical steel sheet according to (31), the width of the sliding band may be from 0.02 to 20 mm.

According to the present invention, during the final annealing, the preferentially-deformable portion which is formed in the lower end portion of the coil is preferentially deformed and the lateral strain developing from the lower end face of the coil is limited by the preferentially-deformable portion, so that the width of the lateral strain portion becomes a substantially constant value. Therefore, the trimming width in a post process may be reduced as much as possible, and thereby the yield is improved.

In addition, according to the present invention, it is possible to form a preferentially-deformable portion such as a groove and a grain boundary sliding portion at a high speed and with a free pattern using a laser beam. Furthermore, it is possible to perform a working using the laser beam without contacting a steel sheet, such that a problem caused by abrasion (time degradation) in a working device (working tool) such as a roller that is used in a mechanical working does not occur. That is, the amount of working does not vary with the passage of time, such that it is not necessary to replace the working device. Furthermore, it is possible to stably form the preferentially-deformable portion that is optimal for suppressing the lateral strain in a production line of a grain-oriented electrical steel sheet by controlling an irradiation energy density and a beam diameter of the laser beam.

### BRIEF DESCRIPTION OF THE DRAWINGS

FIG. 1 is a diagram illustrating an example of a final annealing apparatus.

FIG. 2A is a schematic diagram illustrating a growing process of a lateral strain in a case where a preferentially-deformable portion is not formed.

FIG. 2B is a diagram illustrating an example of an evaluation method of a lateral strain of the present invention.

FIG. 3A is an explanatory diagram illustrating a position of the preferentially-deformable portion.

FIG. 3B is a schematic diagram illustrating a growing process of a lateral strain during a final annealing in a case where a preferentially-deformable portion is formed.

FIG. 4 is a diagram illustrating an example of a condensed shape of a laser beam.

FIG. 5 is a diagram schematically illustrating an example of a first embodiment of the present invention.

FIG. 6A is a diagram schematically illustrating the cross-sectional shape of a groove formed on a single face of an end region of a steel sheet.

FIG. 6B is a diagram schematically illustrating the cross-sectional shape of grooves formed on both faces of an end region of a steel sheet.

FIG. 7 is a diagram schematically illustrating an example of a second embodiment of the present invention.

FIG. 8A is an image of a metallographic structure that is adjacent to a grain boundary sliding portion subjected to a laser irradiation performed according to the second embodiment.

FIG. 8B is an image of a metallographic structure that is adjacent to a grain boundary sliding portion subjected to a laser irradiation performed according to a modified example of the second embodiment.

FIG. 8C is an image of a metallographic structure to which a laser irradiation is not performed.

### DETAILED DESCRIPTION OF THE INVENTION

Hereinafter, exemplary embodiments of the present invention will be described in detail with reference to the accompanying drawings. Further, in this specification and the accompanying drawings, like reference symbols will be given to like components having substantially the same functions, and redundant description thereof will be omitted.

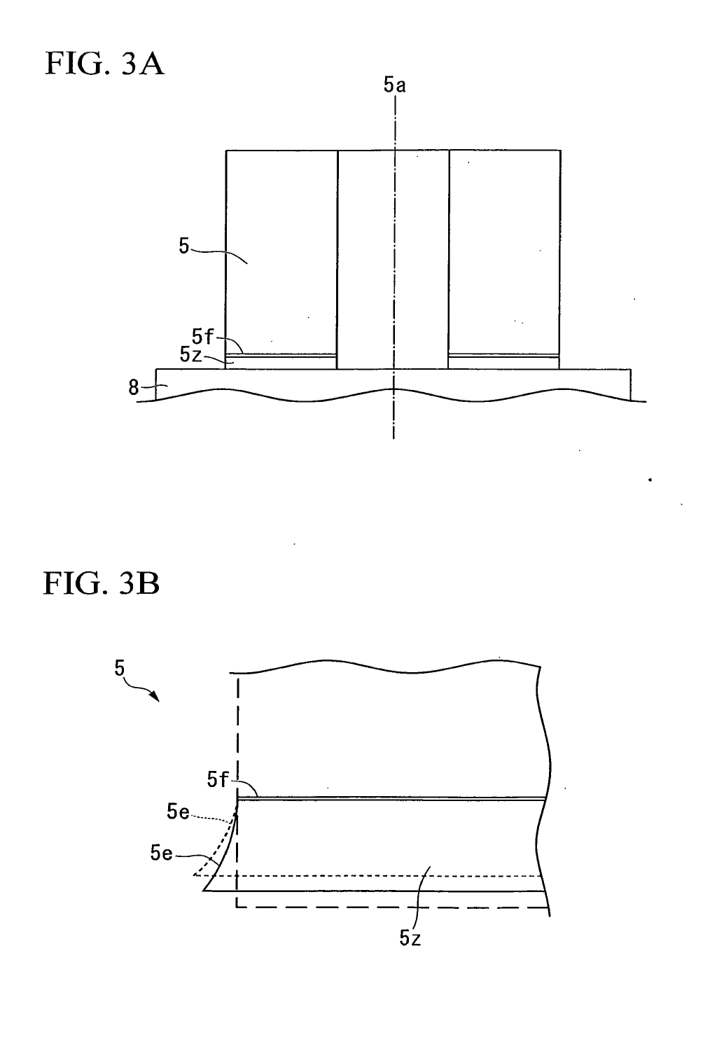

In the present invention, as shown in FIG. 3A, at a position on a coil that is spaced at a predetermined distance from a contact position of a coil 5 and a coil receiver 8, a preferentially-deformable portion 5f having a weak mechanical strength is formed along a rolling direction of the coil 5 (rolling direction of a steel sheet). In a case where a load is applied to the coil 5 in a high temperature annealing furnace, the preferentially-deformable portion 5f is first deformed by buckling or sliding (slip), the load applied to a portion located in the upper direction of the preferentially-deformable portion 5f is dispersed, and thereby enlargement and variation in the width of the lateral strain portion are suppressed. In addition, the lateral strain portion is a deformation region of the end portion of the steel sheet, which satisfies a condition where the height h of a wave exceeds 2 mm or a condition where a steepness s expressed by the above Equation (1) exceeds 1.5% (exceeds 0.015).

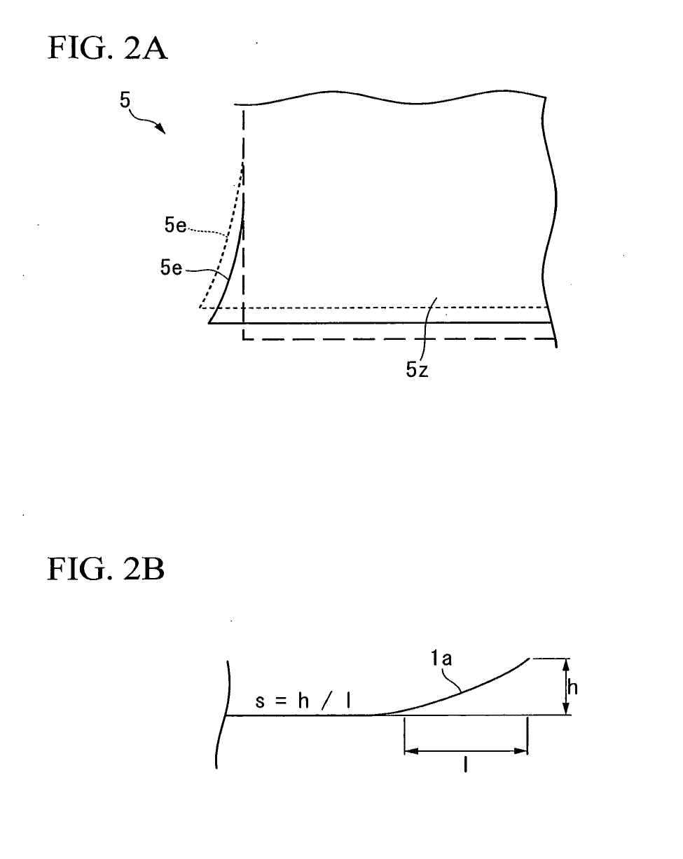

Next, an effect of the preferentially-deformable portion 5f in a method of manufacturing the grain-oriented electrical steel sheet of the present invention will be described in detail using FIGS. 2A and 3B. FIG. 2A shows a schematic diagram illustrating a growing process of the lateral strain portion 5e during a final annealing in a case where the preferentially-deformable portion 5f according to the present invention is not formed. FIG. 3B shows a schematic diagram illustrating a growing process of the lateral strain portion 5e during a final annealing in a case where the preferentially-deformable portion 5f according to the present invention is formed. In addition, in FIGS. 2A and 3B, the solid line shows a schematic diagram in which the lower end portion of the coil at the time of the final annealing is enlarged, the dotted line shows a schematic diagram in which the lower end portion of the coil after the final annealing is enlarged, and the broken line shows a schematic diagram in which the lower end portion of the coil before the final annealing is enlarged. As shown in FIG. 2A, if the preferentially-deformable portion 5f is not formed in the coil 5, a lateral strain portion 5e progresses from a lower end face of the coil 5 toward an upper side with the passage of annealing time (compare between the upper end position of the lateral strain portion 5e on the solid line and the upper end position of the lateral strain portion 5e on the dotted line). The width (length in the vertical direction) of the lateral strain portion 5e is enlarged according to the annealing time, and varies in the longitudinal direction (rolling direction) of the coil 5 due to non-uniformity in the strength of the coil 5 at high temperatures (secondary recrystallization).

However, as shown in FIG. 3B, when the preferentially-deformable portion 5f is formed on the coil 5, the preferentially-deformable portion 5f is preferentially deformed. Therefore, the lateral strain portion 5e does not progress from the preferentially-deformable portion 5f toward the upper side with the passage of annealing time (compare between the upper end position of the lateral strain portion 5e on the solid line and an upper end position of the lateral strain portion 5e on the dotted line). Accordingly, the width of the lateral strain portion 5e does not depend on the annealing time, and is determined by the position of the preferentially-deformable portion 5f. Furthermore, even for the non-uniformity in the strength of the coil 5 at high temperatures (secondary recrystallization), the width of the lateral strain portion 5e does not vary in the longitudinal direction (rolling direction) of the coil 5.

As described above, in the present invention, the preferentially-deformable portion is formed at the end region (lower end portion of the coil) of the steel sheet so as to be parallel with the rolling direction of the steel sheet, such that the width of the lateral strain portion is limited, and thereby it is possible to improve the yield of the grain-oriented electrical steel sheet.

In addition, a specific example of the preferentially-deformable portion of the present invention will be described. It is necessary that the mechanical strength of the preferentially-deformable portion at the time of the final annealing is made to be sufficiently small so that the preferentially-deformable portion shows the above-described effect. In the present invention, the preferentially-deformable portion is, for example, a groove portion having a groove or a grain boundary sliding portion described later. In a case where the preferentially-deformable portion is the groove portion, when the strength of the coil decreases at high temperatures, stress is concentrated on the groove portion and thereby the groove portion is preferentially deformed. In addition, when the preferentially-deformable portion is the grain boundary sliding portion (slidable portion by a grain boundary), the grain boundary sliding portion preferentially causes a high temperature sliding (deformation).

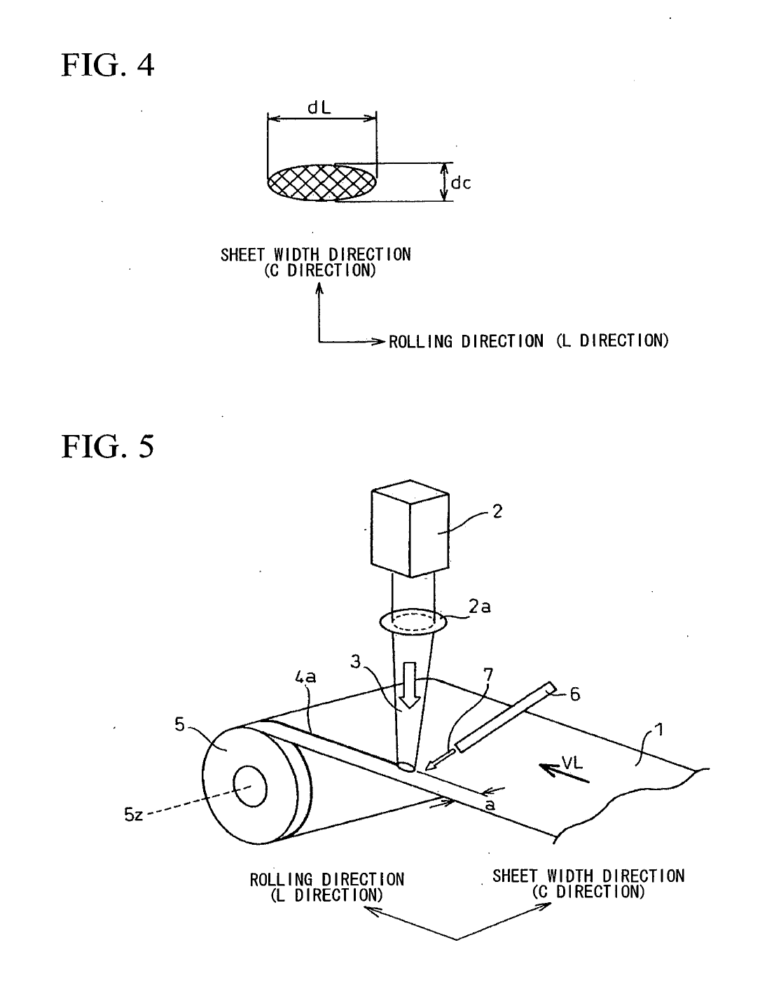

It is necessary that the preferentially-deformable portion is accurately formed within a predetermined narrow range to be parallel with an end face of the steel sheet so that the preferentially-deformable portion is preferentially deformed. Therefore, it is preferable that as a working device capable of condensing a section to be worked (for example, a laser irradiation section) to form the preferentially-deformable portion, for example, a laser device is used. When the preferentially-deformable portion is formed using the laser device, the width of the preferentially-deformable portion can be controlled within a predetermined narrow range by adjusting a condensing diameter of the laser beam. As shown in FIG. 4, the condensed shape of the laser beam is an elliptical shape that has a diameter dc in the sheet width direction (C direction) and a diameter dL in the rolling direction (L direction).

Here, it is necessary that the laser irradiation section is spaced from the end face of the steel sheet so as to satisfy the following Equation (2).

a>dc/2 (2)

In addition, the energy density Ed input to the preferentially-deformable portion using the laser device is defined by the Equation (3) using a laser power P (W), the diameter dc (mm) in the sheet width direction (C direction) of the laser beam, and the feeding speed VL (mm/s) of a steel sheet.

Ed=(4/π)×P/(dc×VL) (3)

The energy density Ed is controlled according to the kind and shape of the preferentially-deformable portion as described later.

In addition, the kind of laser is not specifically limited as long as the laser can form the preferentially-deformable portion with a predetermined shape on the surface of the steel sheet. For example, a CO₂ laser, a YAG laser, a semiconductor laser, a fiber laser, or the like may be used.

In addition, the preferentially-deformable portion formed by the working device may be continuously formed or may be formed over the entire length of the steel sheet in the rolling direction. However, for energy saving, the preferentially-deformable portion may be discontinuously formed or may be formed at a part of the steel sheet in the rolling direction. For example, when a continuous-wave laser beam is used, the preferentially-deformable portion, which is continuous in the rolling direction, is formed. In addition, for example, when a pulse laser is used, a discontinuous preferentially-deformable portion (for example, a preferentially-deformable portion having a shape of a dotted line) is formed. Preferentially-deformable portions may be formed in plural so as to be parallel with each other.

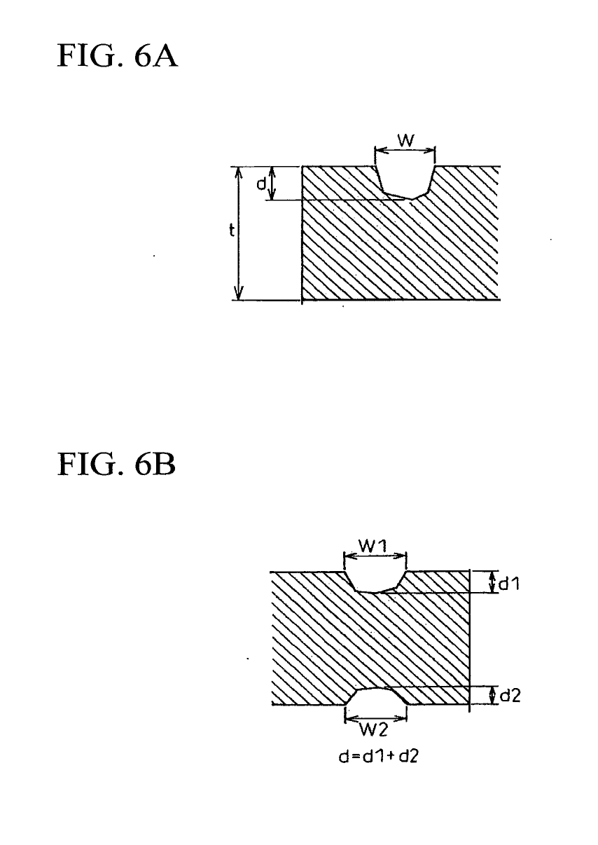

Hereinafter, first, description will be given with respect to a case where the preferentially-deformable portion is a groove portion. FIG. 5 schematically shows an example of a first embodiment of the present invention to form the groove portion.

In the first embodiment shown in FIG. 5, a position spaced with a distance a from an end face in the width direction of the steel sheet (grain-oriented electrical steel sheet) 1 is irradiated with a laser beam 3 that is output from a laser device 2 and is condensed by a condensing lens 2a. By the irradiation of the laser beam 3, the irradiated portion of the steel sheet is fused or vaporized. Furthermore, highly-pressurized assist gas 7 is injected from a nozzle 6 with respect to the irradiated portion to blow away the remaining fused material and thereby a groove portion 4a having a groove is formed.

The steel sheet 1 is fed in the L direction (rolling direction) at a velocity VL, such that the groove portion 4a is formed along the rolling direction of the steel sheet. After the groove portion 4a is formed on the steel sheet 1, an annealing separator is applied onto the surface of the steel sheet 1, and the steel sheet 1 is wound as a coil 5.

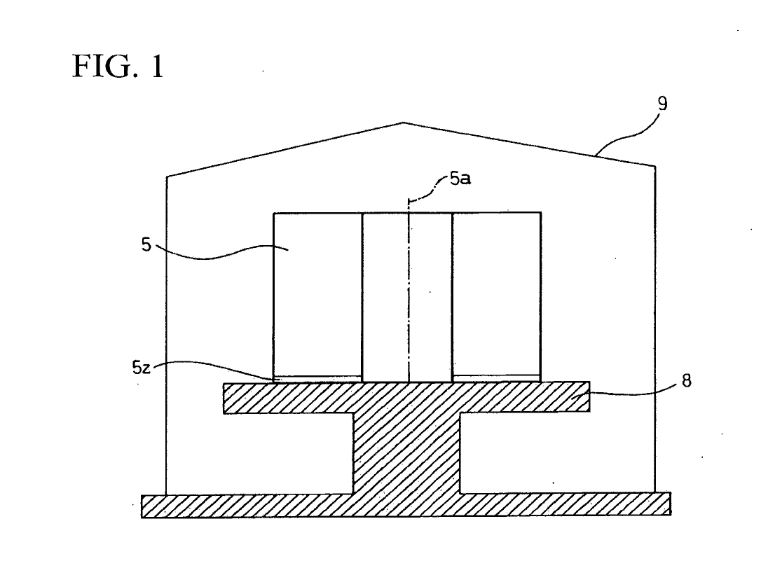

As shown in FIG. 1, the final annealing is performed with respect to the coil 5 in a state where the end portion (end region), which has the groove portion 4a, of a coil-shaped steel sheet 1 faces the lower side. In the final annealing, it is preferable that the coil-shaped steel sheet 1 is placed in a manner such that the coil axis 5a of the coil-shaped steel sheet 1 (coil 5) is vertical to the coil receiver 8 inside an annealing apparatus 9.

In order to improve the yield of the grain-oriented electrical steel sheet, it is preferable that the position (groove portion or working position) to be irradiated with the laser beam, that is, a distance a at which the groove is to be formed is 100 mm or less from the end face (end face in the end region) of the steel sheet. In order to further improve the yield, more preferably, the groove portion is formed at a distance of 30 mm or less from the end face in the end region of the steel sheet. In order to optimize the yield, the distance a may be determined according to the weight of the coil. The inventors found that even in a case of a large-scale coil having the largest sheet width, when the groove portion is formed at a position within 100 mm from the end face of the steel sheet, it is possible to suppress enlargement and variation in the width of the lateral strain portion in a practical operation.

In addition, in order to produce the effect of the groove portion without the contact between the groove portion and the coil receiver, it is preferable that the groove portion is formed at a distance of 5 mm or more from the end face of the end region of the steel sheet. In order to further secure the effect of the groove portion, it is preferable that the groove portion is formed at a distance of 10 mm or more from the end face of the end region of the steel sheet.

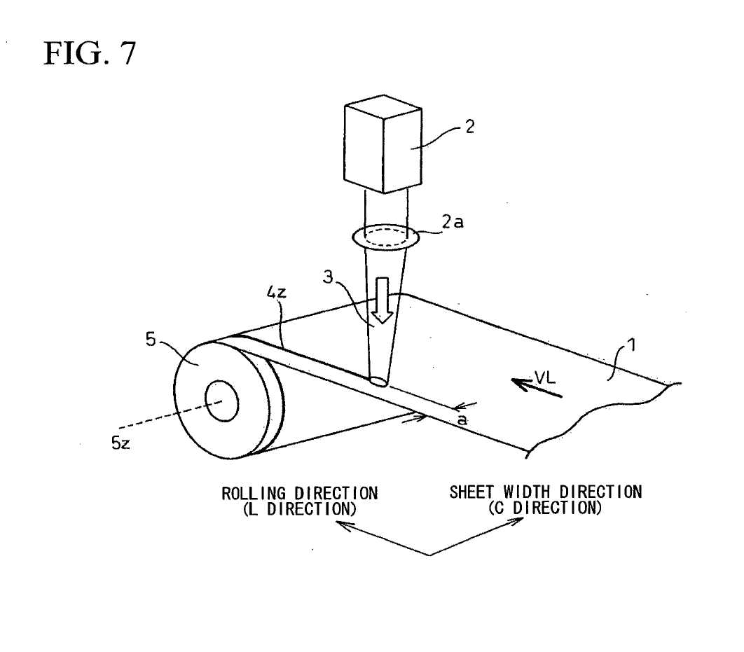

FIGS. 6A and 6B schematically show a cross-section of the groove formed according to the present invention. In FIG. 6A, a groove having a groove width W and a groove depth d is formed on a single face of the steel sheet having a thickness t. In FIG. 6B, a groove having a groove width W1 and a groove depth d1 and a groove having a groove width W2 and a groove depth d2 (W1≈W2, d=d1+d2) are formed on both faces of the steel sheet having a thickness t.

As a method of forming the groove with a predetermined shape in a single face of the steel sheet shown in FIG. 6A, one working device such as the laser device 2 of FIG. 5 may be used. In addition, as shown in FIG. 6B, when grooves with a predetermined shape are formed on both faces at positions substantially opposite to each other, the mechanical strength of the groove portion further decreases, such that the lateral strain suppressing effect is significantly further obtained.

The shape of the groove of the groove portion with a low mechanical strength is designed in consideration of a sheet thickness of the steel sheet. Specifically, it is preferable that the groove is formed so that a ratio d/t of the depth d to the sheet thickness t satisfies the following Equation (4).

0.05≦d/t≦0.7 (4)

Here, in a case of forming the groove on both faces, as shown in FIG. 6B, the depths of the grooves formed on the front face and the rear face are set as d1 and d2, respectively, and a total depth (d1+d2) of these grooves is set as d.

In the present invention, even when the depth of the groove formed on the front face of the steel sheet is relatively shallow, the groove has an effect on the mechanical strength of the groove portion of the steel sheet in an annealing process over an extended period at high temperatures. However, when d/t is less than 0.05, even when the annealing is performed over an extended period at high temperatures, the mechanical strength of the groove portion does not decrease significantly, such that the lateral strain suppressing effect is not obtained. Therefore, in order to reliably obtain the lateral strain suppressing effect, it is preferable that d/t is 0.05 or more. More preferably, d/t is 0.1 or more.

On the other hand, when d/t exceeds 0.7, the mechanical strength of the groove portion decreases enormously. Therefore, when the steel sheet is wound in a coil shape, the steel sheet is greatly deformed due to coiling tension (winding tension) and thereby the coiling becomes difficult. In some cases, a problem that the steel sheet is cut occurs. Therefore, it is preferable that d/t is 0.7 or less. More preferably, d/t is 0.5 or less.

Specifically, if a steel sheet with a thickness t of from 0.1 mm to 0.5 mm is used, it is preferable that the lower limit of the depth d is 0.005 mm, and more preferably, 0.01 mm. In addition, it is preferable that the upper limit of the depth d is 0.35 mm, and more preferably, 0.25 mm.

In addition, it is preferable that the groove width W of the groove portion is from 0.03 mm to 10 mm. When the groove width W is less than 0.03 mm, the mechanical strength in the groove portion does not decrease sufficiently, and the lateral strain suppressing effect is not obtained. On the other hand, when the groove width W is greater than 10 mm, the mechanical strength of the groove portion decreases enormously, and thereby the coiling becomes difficult.

In a case where the groove is formed by the irradiation of the laser beam, the groove width can be controlled by adjusting the condensing diameter of the laser beam.

In addition, the groove depth can be controlled by adjusting the laser power in combination with the feeding speed of the steel sheet. Therefore, in the present invention, when the laser beam is used, it is possible to easily form a groove, which has a shape suitable for suppressing the lateral strain, on a single face or both faces of the end region (first end portion) in one side of the steel sheet (grain-oriented electrical steel sheet) before the final annealing.

In addition, the inventors have reviewed an optimal range of an energy density Ed of the laser device in a case of forming the groove portion using the laser device. Here, the energy density Ed input to the groove portion by the laser device is defined by the above-described Equation (3).

In regard to the energy density Ed, as a result of experiment until now, when Ed is 0.5 J/mm² or more, the laser irradiation portion is fused, and thereby it is possible to form a groove portion with a sufficient groove depth. However, when Ed is less than 0.5 J/mm², it is difficult to form the groove portion to be deformed preferentially during the final annealing. On the other hand, when Ed exceeds 5.0 J/mm², the steel sheet is cut by the laser irradiation, and an energy efficiency decreases enormously. Therefore, the preferred range of Ed is a range expressed by the Equation (5).

0.5 J/mm²≦Ed≦5.0 J/mm² (5)

The energy density Ed is controlled to satisfy the Equation (5) by appropriately setting the laser power P, the diameter dc in the sheet width direction (C direction) of the laser beam and the feeding speed VL of the steel sheet.

In addition, when forming the groove, fused material and scattered material are removed by a laser irradiation using the assist gas 7 shown in FIG. 5. Therefore, it is possible to prevent a problem that the strength of the groove portion increases by a work hardening accompanying the deformation. In addition, the working device (for example, the laser device 2, condensing lens 2a and nozzle 6 shown in FIG. 5) does not come into contact with the steel sheet, such that it is possible to prevent a problem caused by time degradation of the working device.

In addition, in the above-described first embodiment shown in FIG. 5, as an example of the working device for forming the groove, the laser device 2 is used. However, any working device may be used as long as the working device can form a groove with a desired shape at high speed. For example, as the working device, a cutting device such as a water jet (injection device for a high pressure water stream with a fine diameter) or a reduction device such as a roller may be used to form the groove with the desired shape. However, for example, it is preferable that the working device does not come into contact with the steel sheet during working like the laser device and time degradation does not occur. Therefore, in the first embodiment shown in FIG. 5, a laser beam working is used, in which a non-contact type high speed working can be performed with superior power density and superior controllability.

Hereinafter, description will be given in detail with respect to a case where the preferentially-deformable portion is a grain boundary sliding portion (portion where a high temperature grain boundary sliding occurs by a secondary recrystallization during the final annealing).

The inventors have found that when a locally heated section with a significantly narrow range is formed on the steel sheet before the final annealing, for example, by the irradiation of a condensed laser beam, a grain boundary of a secondary crystallization occurs easily in the heated section during the final annealing. In such a grain boundary, the grain boundary sliding occurs easily at high temperatures and the mechanical strength under high temperatures is decreased.

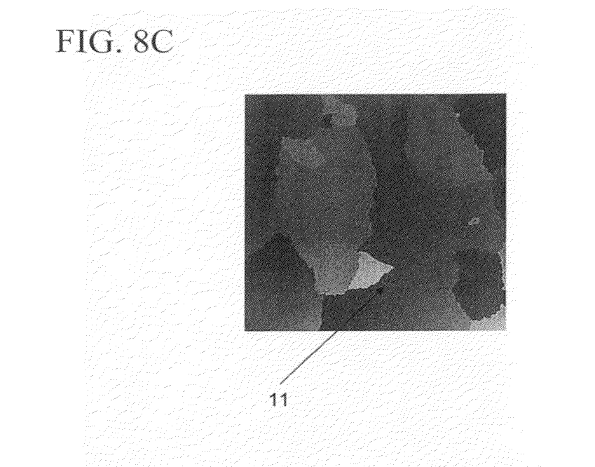

Here, the inventors arrived an idea that by forming a grain boundary sliding portion having a weak mechanical strength at a position on a coil that is spaced at a predetermined distance from the contact position of the coil and the coil receiver along the rolling direction of the coil (rolling direction of a steel sheet), the lateral strain (strain energy) to be formed from the lower end of the coil is absorbed by the deformation of the grain boundary sliding portion and the enlargement of the lateral strain toward the upper side from the grain boundary sliding portion is suppressed. In addition, the grain boundary sliding portion is a linear region where a high temperature sliding portion such a grain boundary is formed during the final annealing. Therefore, it is not necessarily necessary that the linear region includes the grain boundary before the final annealing. That is, the high temperature sliding portion such as the grain boundary is formed in the grain boundary sliding portion at least after the final annealing. As shown in FIG. 8A, the grain boundary sliding portion (high temperature sliding portion) after the final annealing may be one grain boundary. In addition, as shown in FIG. 8B, the grain boundary sliding portion (high temperature sliding portion) after the final annealing may be a sliding band including crystal grains In addition, the crystal grains may be long, thin crystal grains or fine crystal grains.

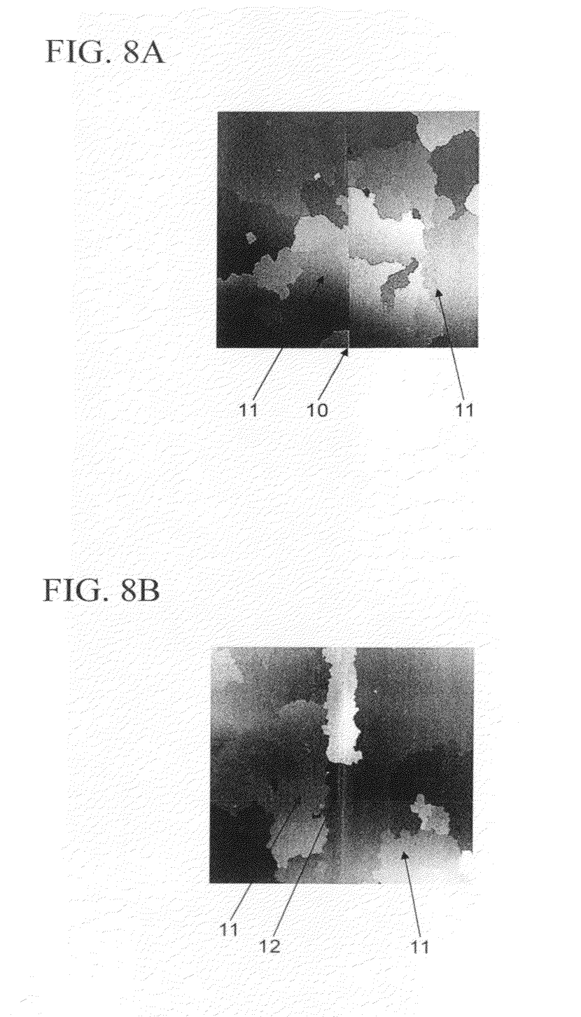

FIG. 7 shows an example schematically illustrating a second embodiment for forming the grain boundary sliding portion. As shown in FIG. 7, a laser beam 3 output from a laser device 2 is condensed by a condensing lens 2a, and a position away from an end face by a distance a in the width direction of the steel sheet 1 (grain-oriented electrical steel sheet) is irradiated with the laser beam.

The steel sheet 1 is fed at a velocity VL in the L direction (rolling direction), such that the grain boundary sliding portion (linear region) 4z that is heated by the laser irradiation is formed along the rolling direction of the steel sheet. After the grain boundary sliding portion 4z is formed on the steel sheet 1, an annealing separator is applied onto a surface of the steel sheet 1, and then the steel sheet 1 is wound into a coil 5. After being wound into the coil, as shown in FIG. 1, the coil 5 is placed on the coil receiver 8 in a manner such that the coil axis is vertically located and the end region (first end portion) including the laser irradiation portion becomes a lower side of the steel sheet, and then the final annealing is performed. At this time, when being placed on the coil receiver 8, an end region (second end portion) not including the laser irradiation portion becomes the upper side of the steel sheet. The steel sheet 1 is subjected to the final annealing in a state where the end region (first end portion) of the coil-shaped steel sheet 1 on which grain boundary sliding portion 4z is formed becomes a lower side. In the final annealing, it is preferable that the coil-shaped steel sheet 1 is disposed in a manner such that the direction of the coil axis 5a of the coil-shaped steel sheet 1 (coil 5) becomes perpendicular to the coil receiver 8 inside the annealing apparatus 9.

In regard to the position of the grain boundary sliding portion, it is preferable that the grain boundary sliding portion is formed at a distance of 5 mm or more from the end face of the end region of the steel sheet so that the strain energy of the lateral strain portion is sufficiently absorbed by the deformation of the grain boundary sliding portion. In order to further secure the effect of the grain boundary sliding portion, it is more preferable that the grain boundary sliding portion is formed at a distance of 10 mm or more from the end face of the end region of the steel sheet.

In addition, in order to improve the yield of the grain-oriented electrical steel sheet, it is preferable that the distance a from the end face of the steel sheet to the grain boundary sliding portion is 100 mm or less. In order to further improve the yield, it is preferable that the groove portion is formed at a distance of 30 mm or less from the end face of the end region of the steel sheet. In order to optimize the yield, the distance a may be determined according to the weight of the coil.

In addition, when the grain boundary sliding portion is the sliding band including the crystal grains (long and thin crystal grains or fine crystal grains) as shown in FIG. 8B, it is preferable that the width of the sliding band is 20 mm or less. When the width of the sliding band is larger than 20 mm, the mechanical strength of the sliding band increases, such that the sliding band does not act as the preferentially-deformable portion (grain boundary sliding portion) during the final annealing. The lower limit of the width of the sliding band is not specifically defined. However, since the crystal grains have a size of 0.02 mm before the final annealing, the lower limit of the width of the sliding band may be 0.02 mm. The width of the sliding band is obtained by averaging the width of the sliding band at each position of the sliding band in the rolling direction. Here, the sliding band is defined as the linear portion with crystal grains.

In order to form the above-described grain boundary sliding portion 4z, it is necessary to use as a working device, for example, a heating device capable of condensing a heating section like the laser device 2.

The inventors have reviewed an optimal range of an energy density Ed of the laser device in a case of forming the grain boundary sliding portion using the laser device. Here, the energy density Ed input to the grain boundary sliding portion 4z by the laser device 2 is defined by the above-described Equation (3).

In regard to the energy density Ed, as a result of experiment until now, when Ed is 0.5 J/mm² or more, the linear grain boundary is generated during the final annealing, and thereby it is possible to cause a sufficient high temperature sliding in the grain boundary sliding portion. However, when Ed is less than 0.5 J/mm², it is difficult to generate the sufficient linear grain boundary necessary for the high temperature sliding during the final annealing. On the other hand, when Ed exceeds 5.0 J/mm², the steel sheet is fused remarkably by the irradiation of laser, and the steel sheet is largely deformed using the laser at the time of re-solidification. Accordingly, there is a problem that the steel sheet cannot be wound into the coil. Therefore, a preferred range of the Ed is within a range expressed by the Equation (6).

0.5 J/mm²≦Ed≦5.0 J/mm² (6)

The energy density Ed is controlled to satisfy the Equation (6) by appropriately setting the laser power P, the diameter dc in the sheet width direction (C direction) of the laser beam, and the feeding speed VL of the steel sheet. It is preferable that the grain boundary sliding portion is formed over the entire sheet thickness. Therefore, in addition to the energy density Ed, the diameter dL in the rolling direction (L direction) may be controlled according to the feeding speed VL of the steel sheet so that a predetermined heating time is maintained.

In addition, the working device that forms the grain boundary sliding portion 4z may be a heating device capable of condensing a heating section. In the second embodiment shown in FIG. 7, since the grain boundary sliding portion (for example, a linear grain boundary at the time of the final annealing) is accurately formed within a predetermined narrow range with a predetermined distance from the end face of the end region of the steel sheet, it is preferable that a laser beam that is superior in controllability of the heating position and heating rate is used.

In the above-described first and second embodiments, as the preferentially-deformable portion, the groove or the grain boundary sliding portion is formed on the steel sheet. However, as the preferentially-deformable portion, both of the groove and the slip deformation portion may be formed.

As described above, in the method of manufacturing the grain-oriented electrical steel sheet according to the present invention, a process of forming the preferentially-deformable portion at the end region of the steel sheet so as to be parallel with the rolling direction of the steel sheet, a process of coiling the steel sheet into a coil shape, and a process of performing the final annealing in a state where the end region of the coil-shaped steel sheet becomes the lower side of the steel sheet are sequentially performed. Furthermore, the process of forming the preferentially-deformable portion is performed after cold rolling. In addition, it is preferable that the process of forming the preferentially-deformable portion on the steel sheet is performed before the process of applying the annealing separator in order to prevent the loss of the annealing separator.

Therefore, in the grain-oriented electrical steel sheet according to the present invention, the thermally-deformed portion (hot-deformed portion, the preferentially-deformable portion after the final annealing) is formed at the end region of the steel sheet to be parallel with the rolling direction of the steel sheet. The thermally-deformed portion may be formed continuously or discontinuously. In addition, the thermally-deformed portion may be formed over the entire length of the steel sheet, or may be formed at a part of the steel sheet in the rolling direction thereof. In addition, it is preferable that the thermally-deformed portion is formed at a distance of 5 to 100 mm from the end face of the end region. In addition, at both sides of the thermally-deformed portion, there are present normal secondary recrystallized grains in which an axis of easy magnetization is oriented in the rolling direction.

The above-described thermally-deformed portion may be a groove. The groove may be formed on a single face or both faces of the steel sheet. In addition, it is preferable that the width of the groove is from 0.03 mm to 10 mm. Furthermore, it is preferable that the depth d of the groove and the thickness t of the steel sheet satisfy the above-described Equation (4).

The above-described thermally-deformed portion may be a single linear crystal grain boundary or a sliding band including a crystal grains It is preferable that the width of the sliding band is from 0.02 mm to 20 mm.

When manufacturing a final product, the above-described grain-oriented electrical steel sheet is used after the deformation region adjacent to the thermally-deformed portion is cut out.

Hereinafter, the first and second embodiment of the present invention will be described in more detail using examples.

### Example 1

An example of the first embodiment of the present invention will be described.

A CO₂ laser was used as the laser device 2 in FIG. 5. A laser power P was controlled to be 1500 W by an electrical input and a condensing shape of the laser was a circular shape with 0.2 mmφ. A steel sheet (grain-oriented electrical steel sheet) 1 with a width of 1000 mm and a thickness t of 0.23 mm after decarburization annealing was fed at a velocity VL of 1000 mm/s in the L direction.

A distance a, which is a laser beam irradiation position, was spaced by 20 mm from an end face of the steel sheet, a surface in one side of the steel sheet was irradiated with a laser beam over the entire length of the coil (entire length in the L direction), and thereby a groove was formed. As assist gas, dried air under a pressure of 0.5 MPa was used. The cross-sectional shape of the formed groove portion had dimensions: a width W of substantially 0.2 mm and a depth d of substantially 0.02 mm. In this case, an energy density Ed of the laser beam was 9.5 J/mm².

After the groove was formed on a surface (single face) of the end region (first end portion) of the steel sheet, MgO as an annealing separator was applied onto the surface of the steel sheet, and the steel sheet 1 was wound into a coil shape. Then, the coil-shaped steel sheet (coil) was subjected to a final annealing at substantially 1200° C. for substantially 20 hours using the annealing apparatus shown in FIG. 1 (Example 1). In addition, as a comparative example, a coil (non-processed coil) in which the groove was not formed was subjected to the same final annealing as described above. The width of the lateral strain of the steel sheet after the final annealing was visually inspected over the entire length of the coil. In addition, the width of a deformation region of the end portion of the steel sheet as the lateral strain portion, which satisfies a condition where the height h of wave exceeds 2 mm or a condition where a steepness s expressed by the above-described Equation (1) exceeds 1.5% (exceeds 0.015), was measured.

Results thereof are shown in Table 1. As shown in Table 1, in the Comparative example where the groove was not formed, the width of the lateral strain portion was wide, as well as variation in the width of the lateral strain portion being large with a value of 40 mm (±20 mm). Especially, lateral strain having a width up to substantially 60 mm was generated and the yield decreased largely. On the other hand, in the Example 1 where the groove portion was formed at a position spaced by distance a from an end face of the coil according to the first embodiment of the present invention, a relatively remarkable bending deformation (buckling distortion) was generated at a position of 20 mm corresponding to the distance a. Therefore, it was possible to remarkably limit the lateral strain from the end face of the coil at a position of nearly the distance a. In addition, it was possible to make the variation in the width of the lateral strain portion small with a value of 6 mm (±3 mm) and the yield was largely improved compared to the Comparative example.

TABLE 1

| | Width of lateral strain | |
|---|---|---|
| Groove | from end face of steel sheet | Remark |
| Yes | 20 ± 3 mm | Example 1 |
| None | 40 ± 20 mm | Comparative |
| | | example |

### Example 2

An example of the second embodiment of the present invention will be described.

A semiconductor laser was used as the laser device 2 of FIG. 7. In the semiconductor laser device, a laser power P could be changed up to 2 kW. In addition, the laser power P could be arbitrarily set using a laser power control device (not shown).

The laser power P was set to 1000 W, and a condensing shape was set to an elliptical shape where dc was 1.2 mm, and dL was 12 mm. A steel sheet 1 after decarburization annealing, which had a width of 1000 mm and a thickness t of 0.23 mm, was fed in the L direction at a velocity VL of 400 mm/s.

The distance a from the end face of the steel sheet, which is the irradiation position of the laser beam, was set to 20 mm, and a surface in one side of the steel sheet was irradiated with the laser beam over the entire length (the entire length in the L direction) of the coil. In this case, the energy density Ed of the laser beam was 2.7 J/mm².

After the laser irradiation, MgO as the annealing separator was applied onto a surface of the steel sheet 1, and then the steel sheet 1 was wound into a coil shape. Then, the coil-shaped steel sheet (coil) was subjected to a final annealing at substantially 1200° C. for substantially 20 hours using the annealing apparatus shown in FIG. 1 (Example 2). In addition, as a comparative example, a coil (non-processed coil) to which the laser irradiation was not performed was subjected to the same final annealing as described above. The width of a lateral strain of the steel sheet after the final annealing was visually inspected over the entire length of the coil. In addition, the width of a deformation region of the end portion of the steel sheet as the lateral strain portion, which satisfied a condition where the height h of wave exceeded 2 mm or a condition where a steepness s expressed by the above-described Equation (1) exceeded 1.5% (exceeded 0.015), was measured.

The results thereof are shown in Table 2. As shown in Table 2, in the Comparative example where the laser irradiation was not performed, the width of the lateral strain portion was wide, as well as variation in the width of the lateral strain portion being large with a value of 40 mm (±20 mm). Especially, lateral strain having a width up to substantially 60 mm was generated and the yield decreased largely. On the other hand, in the Example 2 where a grain boundary sliding portion was formed by the laser irradiation at a position spaced at distance a from the end face of the coil according to the second embodiment of the present invention, a high temperature sliding was generated at a position of 20 mm corresponding to the distance a. Therefore, it was possible to remarkably limit the lateral strain from the end face of the coil at a position of nearly the distance a. In addition, it was possible to make the variation in the width of the lateral strain portion small with a value of 8 mm (±4 mm) as compared to Comparative example. In addition, in the Example 2, the maximum width of the strain was 28 mm, and the yield was largely improved compared to the Comparative example (maximum width of the strain was 60 mm).

TABLE 2

| Laser | Width of lateral strain | |
|---|---|---|
| irradiation | from end face of steel sheet | Remark |
| Yes | 20 ± 4 mm | Example 2 |
| None | 40 ± 20 mm | Comparative |
| | | example |

FIGS. 8A, 8B and 8C show observation results of a crystalline structure of the steel sheet, after the surface of the steel sheet after the final annealing was washed using an acid and thereby a film thereof was removed. FIG. 8A is an image of a metallographic structure at the vicinity of the grain boundary sliding portion that was subjected to the laser irradiation according to the second embodiment of the present invention. In addition, FIG. 8C is an image of a metallographic structure that was not subjected to the laser irradiation as the Comparative example.

In a case where laser irradiation was performed according to the second embodiment, a linear crystal grain boundary 10 was formed at the periphery (grain boundary sliding portion) of the laser irradiation portion after the final annealing. Normal secondary recrystallized grains 11 in which the axis of easy magnetization was oriented in the rolling direction, which is necessary for the grain-oriented electrical steel sheet, were obtained on both sides of the line-shaped grain boundary 10. In addition, FIG. 8B shows a modified example where the laser irradiation was performed with the same conditions as the second embodiment and the final annealing time was shorter than that in the second embodiment. In the modified example shown in FIG. 8B as the second embodiment, a sliding band 12 including crystal grains was formed. In the modified example, the crystal grains in the sliding band were long, thin crystal grains. As described above, the grain boundary sliding portion after the final annealing is the linear crystal grain boundary 10 or the sliding band 12 including the crystal grains. The sliding band 12 including the crystal grains is apt to be generated in a case where for example, the energy density of the laser beam is low or the annealing time is short compared to conditions where the linear crystal grain boundary 10 is formed. However, the conditions where the linear crystal grain boundary 10 is generated and the conditions where the sliding band including the crystal grains 12 is generated also vary depending on the chemical composition of the steel sheet, the temperature of the final annealing, the time of the final annealing, the atmosphere of the final annealing, in addition to the laser conditions, such as the energy density of the laser beam, such that the details of the conditions are unclear.

In the crystal grain boundary 10 according to the second embodiment, the grain boundary sliding is apt to be generated at high temperatures of 900° C. or more during the final annealing, and the mechanical strength thereof is lower than that of other portions. Therefore, it is considered that when a load is applied to the coil in a state where the coil is brought into contact with the coil receiver, the linear crystal grain boundary 10 is at first deformed due to sliding, the load applied to the upper side in relation to the crystal grain boundary 10 is dispersed, and thereby the enlargement and variation in the width of the lateral strain portion are suppressed.

In addition, the sliding mechanism at the time of the above-described annealing depends on the linear crystal grain boundary formed at the grain boundary sliding portion. However, like the modified example of the second embodiment, the sliding mechanism may be, for example, a high temperature sliding due to a sliding band that is formed along the rolling direction and includes the crystal grains. The crystal grains may be fine crystal grains or long, thin crystal grains. For example, in the modified example of the second embodiment, the grain boundary of crystal grains (long, thin crystal grains) in the sliding band 12 is deformed due to sliding similarly to the above-described linear crystal grain boundary 10 and thereby the enlargement and variation of the lateral strain portion is suppressed.

### Example 3

Next, the inventors investigated a preferred range of the energy density Ed of the laser irradiation in the second embodiment. That is, the inventors investigated the relationship between the degree of grain refining in the laser irradiation portion and the energy density Ed under a condition where the distance a was 20 mm. Here, the feeding speed VL was set to 1000 mm/s, and the diameter dc of the laser beam in the C direction was set to a constant value of 1.2 mm. The Ed expressed by the above-described Equation (3) was changed by changing the laser power P within a range of 200 to 5000 W and then investigated a crystal state (metallographic structure) of the steel sheet after the secondary recrystallization.

As a result, when the energy density Ed was 0.5 J/mm² or more, it was possible to generate a predetermined crystalline structure (linear grain boundary) at the time of the final annealing. However, when the energy density Ed was less than 0.5 J/mm², it was difficult to generate a predetermined crystalline structure (linear grain boundary) at the time of the final annealing. On the other hand, when the energy density Ed exceeded 5.0 J/mm², the steel sheet was fused remarkably by the laser irradiation, and the steel sheet was largely deformed at the time of re-solidification. Accordingly, there was a problem that the steel sheet could not be wound into the coil. Therefore, the preferred range of the Ed was within the range expressed by the Equation (6).

The above-described conditions of the Examples 1 to 3 are exemplary examples adopted to confirm the practicability and effect of the present invention. However, the present invention is not limited to the Examples 1 to 3. The present invention can adopt various conditions to accomplish the object of the present invention without departing from the scope of the invention.

According to the present invention, the width of the lateral strain portion is made to be nearly constant value, the trimming width in the post process can be diminished as much as possible, and the yield is improved. Therefore, the industrial applicability in the manufacture of the electromagnetic steel sheet is high.

### REFERENCE SYMBOL LIST

1: Grain-oriented electrical steel sheet
2: Laser device
2a: Condensing lens
3: Laser beam
4a: Groove portion (preferentially-deformable portion)
4z: Grain boundary sliding portion (linear region, preferentially-deformable portion)
5: Coil
5a: Coil axis
5e: Lateral strain portion
5f: Preferentially-deformable portion
5z: Lower end portion (end region, first end portion)
6: Nozzle
7: Assist gas
8: Coil receiver
9: Annealing furnace cover
10: Linear crystal grain boundary (linear grain boundary, grain boundary)
11: Secondary recrystallized grain
12: Sliding band

What is claimed is:

1. A producing method of a grain-oriented electrical steel sheet, the method comprising:
forming a preferentially-deformable portion in an end region of a steel sheet so as to be parallel with a rolling direction of the steel sheet;
coiling the steel sheet; and
performing a final annealing to the steel sheet after disposing the steel sheet in a manner such that the end region becomes a lower side of the steel sheet.

2. The producing method of a grain-oriented electrical steel sheet according to claim 1,
wherein the preferentially-deformable portion is continuously formed.

3. The producing method of a grain-oriented electrical steel sheet according to claim 1,
wherein the preferentially-deformable portion is discontinuously formed.

4. The producing method of a grain-oriented electrical steel sheet according to claim 1,
wherein the preferentially-deformable portion is formed over an entire length of the steel sheet.

5. The producing method of a grain-oriented electrical steel sheet according to claim 1,
wherein the preferentially-deformable portion is formed at a part of the steel sheet in the rolling direction.

6. The producing method of a grain-oriented electrical steel sheet according to claim 1,
wherein the preferentially-deformable portion is formed at a distance of 5 to 100 mm from an end face of the end region.

7. The producing method of a grain-oriented electrical steel sheet according to claim 1,
wherein when the final annealing is performed, the steel sheet is disposed in a manner such that a direction of a coil axis of the steel sheet after being wound into the coil shape becomes perpendicular to the coil receiver.

8. The producing method of a grain-oriented electrical steel sheet according to claim 1,
wherein the preferentially-deformable portion is formed before an annealing separator is applied on the steel sheet.

9. The producing method of a grain-oriented electrical steel sheet according to claim 1,
wherein the preferentially-deformable portion is formed by irradiation of a laser beam.

10. The producing method of a grain-oriented electrical steel sheet according to claim 1,
wherein a groove is formed in the preferentially-deformable portion.

11. The producing method of a grain-oriented electrical steel sheet according to claim 10,
wherein the groove is formed on a single face of the steel sheet.

12. The producing method of a grain-oriented electrical steel sheet according to claim 10,
wherein the groove is formed on both faces of the steel sheet.

13. The producing method of a grain-oriented electrical steel sheet according to claim 10,
wherein a width of the groove is from 0.03 to 10 mm.

14. The producing method of a grain-oriented electrical steel sheet according to claim 10,
wherein a depth d of the groove and a thickness t of the steel sheet satisfy an equation 0.05≦d/t≦0.7.

15. The producing method of a grain-oriented electrical steel sheet according to claim 1,
wherein the preferentially-deformable portion is a grain boundary sliding portion.

16. The producing method of a grain-oriented electrical steel sheet according to claim 15,
wherein the grain boundary sliding portion after the final annealing is one linear crystal grain boundary.

17. The producing method of a grain-oriented electrical steel sheet according to claim 15,
wherein the grain boundary sliding portion after the final annealing is a sliding band including crystal grains.

18. The producing method of a grain-oriented electrical steel sheet according to claim 17,
wherein a width of the sliding band is from 0.02 to 20 mm.

19. A grain-oriented electrical steel sheet in which a thermally-deformed portion is formed at an end region of a steel sheet so as to be parallel with a rolling direction of the steel sheet.

20. The grain-oriented electrical steel sheet according to claim 19,
wherein the thermally-deformed portion is continuously formed.

21. The grain-oriented electrical steel sheet according to claim 19,
wherein the thermally-deformed portion is discontinuously formed.

22. The grain-oriented electrical steel sheet according to claim 19,
wherein the thermally-deformed portion is formed over an entire length of the steel sheet.

23. The grain-oriented electrical steel sheet according to claim 19,
wherein the thermally-deformed portion is formed at a part of the steel sheet in the rolling direction.

24. The grain-oriented electrical steel sheet according to claim 19,
wherein the thermally-deformed portion is formed at a distance of 5 to 100 mm from an end face of the end region.

25. The grain-oriented electrical steel sheet according to claim 19,
wherein the thermally-deformed portion is a groove.

26. The grain-oriented electrical steel sheet according to claim 25,
wherein the groove is formed on a single face of the steel sheet.

27. The grain-oriented electrical steel sheet according to claim 25,
wherein the groove is formed on both faces of the steel sheet.

28. The grain-oriented electrical steel sheet according to claim 25,
wherein a width of the groove is from 0.03 to 10 mm.

29. The grain-oriented electrical steel sheet according to claim 25,
wherein a depth d of the groove and a thickness t of the steel sheet satisfy an equation 0.05≦d/t≦0.7.

30. The grain-oriented electrical steel sheet according to claim 19,
wherein the thermally-deformed portion is one linear crystal grain boundary.

31. The grain-oriented electrical steel sheet according to claim 19,
wherein the thermally-deformed portion is a sliding band including crystal grains.

32. The grain-oriented electrical steel sheet according to claim 31,
wherein the width of the sliding band is from 0.02 to 20 mm.
